(19) United States
(12) Patent Application Publication
(10) Pub. No.: US 2026/0074310 A1
(43) Pub. Date: Mar. 12, 2026

(54) SECONDARY BATTERY TEST APPARATUS AND TEST METHOD USING THE SAME

(71) Applicant: SK On Co., Ltd., Seoul (KR)

(72) Inventors: Jin Woo SON, Seoul (KR); Su A KIM, Seoul (KR); Sang Tae AN, Seoul (KR)

(21) Appl. No.: 19/312,324

(22) Filed: Aug. 28, 2025

(30) Foreign Application Priority Data
Sep. 9, 2024 (KR) 10-2024-0122074

(51) Int. Cl. H01M 10/42

(52) U.S. Cl. CPC H01M 10/4285

(57) ABSTRACT

A secondary battery test apparatus and a test method using the same are disclosed. According to one aspect of the present disclosure, there is provided a secondary battery test apparatus including an outer case having an inner chamber, and an inner case disposed in the inner chamber, wherein the inner case includes a plurality of partition spaces, in which each secondary battery, which is a test subject, is disposed, and a barrier cover that is fastened to a barrier, which is a test subject, between adjacent partition spaces to seal a space between the barrier and the inner case between the adjacent partition spaces.

### CROSS-REFERENCE TO RELATED APPLICATION

This application claims priority to and the benefit of Korean Patent Application No. 10-2024-0122074, filed on September 9, 2024, the disclosure of which is incorporated herein by reference in its entirety.

### BACKGROUND

### 1. Field of the Invention

Embodiments of the present disclosure relate to a secondary battery test apparatus and a test method.

### 2. Discussion of Related Art

A secondary battery is one of energy storage means which can be charged and discharged through electrochemical reactions. The secondary battery is widely used in various fields in which electrical energy is used. For example, secondary batteries are widely utilized in the field of mobile devices such as a cell phone, a notebook, a tablet, and the like, and are being explored for wider utilization in the field of transportation means such as vehicles, aircraft, ships, and the like. Further, demand for secondary batteries is rapidly increasing in the field of energy storage systems (ESSs) for utilizing surplus electricity.

Some secondary batteries, such as lithium ion batteries, may experience a thermal runaway phenomenon in which the temperature rises dramatically due to a rapid chemical reaction inside the battery. It is known that thermal runaway may be generated by various causes such as overcharging or overdischarging, short circuits inside and outside the battery, an excessive internal temperature increase, physical damage to the battery due to external foreign materials, and the like. Since the thermal runaway of the secondary battery may cause serious safety problems, the performance, safety, and the like of the secondary battery or related components need to be properly tested and evaluated under an environment similar to thermal runaway.

### SUMMARY OF THE INVENTION

Embodiments of the present disclosure are directed to providing a secondary battery test apparatus and a test method that may be used for testing a secondary battery.

Further, some embodiments of the present disclosure are directed to providing a secondary battery test apparatus and a test method that may be used for testing a thermal runaway situation of the secondary battery.

Further, some embodiments of the present disclosure are directed to providing a secondary battery test apparatus and a test method capable of performing a performance test on a plurality of secondary batteries and a plurality of barriers.

Further, some embodiments of the present disclosure are directed to providing a secondary battery test apparatus and a test method capable of reducing the cost, time, and resources required for the test.

Some embodiments of the present disclosure may be widely applied in the field of green technologies such as an electric vehicle and a battery charging station as well as solar power generation and wind power generation using batteries. Further, at least some embodiments of the present disclosure may be used in an eco-friendly electric vehicle, a hybrid vehicle, and the like to prevent climate change by suppressing air pollution and greenhouse gas emissions.

According to an aspect of the present disclosure, there is provided a secondary battery test apparatus including an outer case having an inner chamber, and an inner case disposed in the inner chamber, wherein the inner case includes a plurality of partition spaces, in which each secondary battery, which is a test subject, is disposed, and a barrier cover fastened to a barrier, which is a test subject, between adjacent partition spaces to seal a space between the barrier and the inner case between the adjacent partition spaces.

In some embodiments, the outer case may include an outer cover that opens and closes the inner chamber, a cover fixing flange extending along an upper edge of the outer case, a plurality of first cover fixing grooves provided along the cover fixing flange, and a plurality of second cover fixing grooves provided along an edge of the outer cover so as to correspond to the plurality of first cover fixing grooves.

In some embodiments, the outer case may include a case installation flange extending in a second direction along a lower edge of the outer case, a plurality of case fixing grooves provided in the case installation flange to fix the case installation flange to an installation surface, a water injection port provided on one surface of the outer case to supply fire extinguishing water to the inner chamber, and a first wiring hole provided in another surface of the outer case to provide a path through which an external cable is introduced and installed into the inner chamber.

In some embodiments, each of the partition spaces may have a predetermined width in a first direction and extends in a second direction, and the plurality of partition spaces may be disposed in the first direction inside the inner case.

In some embodiments, the barrier cover may include an upper end extension portion extending in a first direction between an upper end of the barrier and an upper surface part of the inner case to seal a space between the upper end of the barrier and the upper surface part of the inner case, a first side end extension portion extending downward from one end portion of the upper end extension portion to seal a space between one end portion of the barrier and a first surface of the inner case, and a second side end extension portion extending downward from an opposite end portion of the upper end extension portion to correspond to the first side end extension portion to seal a space between the opposite end portion of the barrier and a third surface of the inner case.

In some embodiments, a barrier coupling groove into which the barrier is inserted and fastened may be provided in an inner periphery of the barrier cover.

In some embodiments, an outer surface of the barrier cover may be covered with a thermally insulating material.

In some embodiments, the inner case may include an upper end cover locking groove into which an upper end of the barrier cover is inserted and locked, a first lower end cover locking groove into which a lower front end portion of the barrier cover is inserted and locked, and a second lower end cover locking groove into which a lower rear end portion of the barrier cover is inserted and locked to correspond to the first lower end cover locking groove.

In some embodiments, a plurality of sets of the upper end cover locking grooves and the first and second lower end cover locking grooves may be disposed spaced apart in the inner case to correspond to the plurality of partition spaces.

In some embodiments, the inner case may include a plurality of second wiring holes disposed spaced apart in a first surface of the inner case to correspond to the plurality of partition spaces, and each of the second wiring holes may provide a path through which an external cable is introduced and installed into each of the partition spaces.

In some embodiments, the inner case may include a plurality of jig fixing brackets provided at a lower end of a second surface of the inner case so that the inner case is fixed to a lower surface of the outer case, and each of the jig fixing brackets may include a jig fixing groove extending in a first direction to adjust a fixing position of the inner case with respect to the outer case.

In some embodiments, the inner case may include a plurality of vent holes disposed in an upper surface of the inner case to correspond to each of the partition spaces, and each of the plurality of vent holes may guide gas generated in each of the partition spaces to the outside of the inner case.

In some embodiments, at least some of the plurality of partition spaces may be provided with a secondary battery of a different type from the other partition spaces as a test subject, and at least some of a plurality of barriers disposed between adjacent partition spaces may be provided as different types of barriers from the other barriers, as test subjects.

According to another aspect of the present disclosure, there is provided a secondary battery test method including arranging each secondary battery to be tested in a plurality of partition spaces provided in an inner case, arranging a barrier to be tested and a barrier cover fastened to the barrier between adjacent partition spaces, and sealing a space between the adjacent partition spaces by the barrier and the barrier cover, arranging the inner case in a inner chamber of an outer case, and applying predetermined test conditions to the secondary battery and testing performance of the secondary battery and the barrier under the applied test conditions.

In some embodiments, the barrier cover may include an upper end extension portion extending in a first direction between an upper end of the barrier and an upper surface part of the inner case to seal a space between the upper end of the barrier and the upper surface part of the inner case, a first side end extension portion extending downward from one end portion of the upper end extension portion to seal a space between one end portion of the barrier and a first surface of the inner case, and a second side end extension portion extending downward from an opposite end portion of the upper end extension portion to correspond to the first side end extension portion to seal a space between the opposite end portion of the barrier and a third surface of the inner case.

In some embodiments, the inner case may include an upper end cover locking groove into which an upper end of the barrier cover is inserted and locked, a first lower end cover locking groove into which a lower front end portion of the barrier cover is inserted and locked, and a second lower end cover locking groove into which a lower rear end portion of the barrier cover is inserted and locked to correspond to the first lower end cover locking groove.

In some embodiments, at least some of the plurality of partition spaces may be provided with a secondary battery of a different type from the other partition spaces as a test subject, and at least some of a plurality of barriers disposed between adjacent partition spaces may be provided as different types of barriers from the other barriers, as test subjects.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a schematic perspective view of a secondary battery test apparatus according to one embodiment of the present disclosure;

FIG. 2 is a perspective view schematically illustrating a state in which an inner case illustrated in FIG. 1 is separated;

FIG. 3 is a perspective view schematically illustrating a state in which a front surface part is removed from the inner case illustrated in FIG. 2;

FIG. 4 is a perspective view schematically illustrating a state in which an upper surface part is removed from the inner case illustrated in FIG. 2;

FIG. 5 is a perspective view schematically illustrating a barrier cover illustrated in FIG. 4;

FIG. 6 is a perspective view schematically illustrating a state in which the secondary battery and the barrier, which are test targets, are disposed in the inner case illustrated in FIG. 2;

FIG. 7 is a perspective view schematically illustrating a state in which the secondary battery is removed from FIG. 6 and the barrier is disposed; and

FIG. 8 is a front view schematically illustrating a state in which the front surface of the inner case is removed from FIG. 6 and the secondary battery and the barrier are disposed.

### DETAILED DESCRIPTION OF EXEMPLARY EMBODIMENTS

Hereinafter, the present disclosure will be described in detail with reference to the accompanying drawings. However, this is merely exemplary, and the present disclosure is not limited to the exemplified specific embodiments.

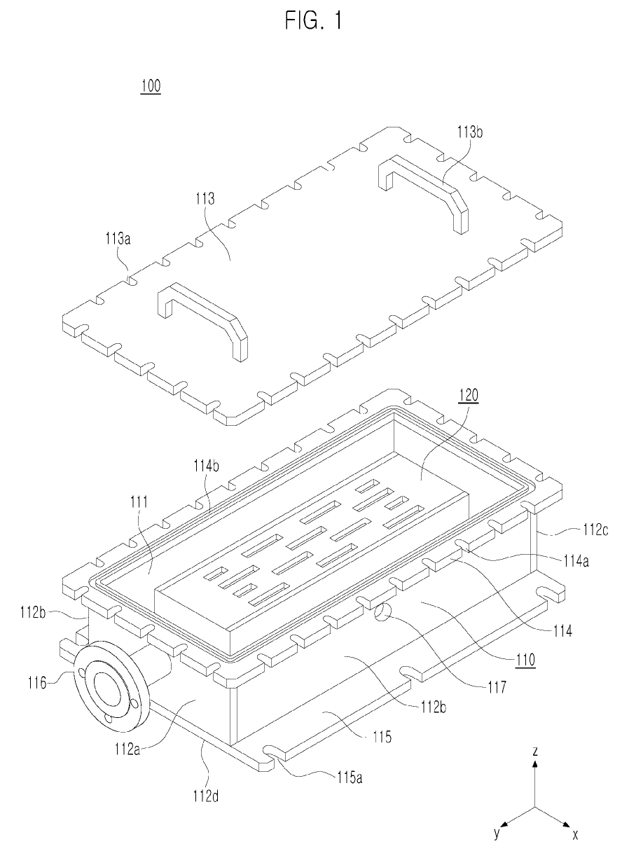

FIG. 1 is a schematic perspective view of a secondary battery test apparatus according to one embodiment of the present disclosure.

For convenience of description, an X-axis direction is referred to as a first direction, a Y-axis direction is referred to as a second direction, and a Z-axis direction is referred to as a third direction based on the coordinate axes shown in FIG .1. Based on the directions shown in FIG. 1, the first direction corresponds to a left-right direction, the second direction corresponds to a front-back direction, and the third direction corresponds to an up-down direction.

Referring to FIG. 1, in some embodiments, a secondary battery test apparatus 100 may include an outer case 110 including an inner chamber 111 and an inner case 120 disposed in the inner chamber 111. In addition, the inner case 120 may include a plurality of partition spaces 125 in which secondary batteries 10 to be tested are disposed and a barrier cover 126 fastened to a barrier 20 to be tested between adjacent partition spaces 125 to seal between the barrier 20 and the inner case 120 between the adjacent partition spaces 125.

Specifically, the secondary battery test apparatus 100 may include the outer case 110. The outer case 110 may be formed in a box shape having the inner chamber 111. In the illustrated embodiment, the outer case 110 has a first surface 112a corresponding to a front surface of the box shape, second surfaces 112b corresponding to left and right side surfaces, a third surface 112c corresponding to a rear surface, and a fourth surface 112d corresponding to a bottom surface, and is illustrated as a substantially rectangular parallelepiped-shaped box with an open upper side.

In some embodiments, the outer case 110 may include an outer cover 113 opening and closing the inner chamber 111. The outer cover 113 may be formed in a plate shape corresponding to a planar shape of the outer case 110 and may be fastened to an upper surface of the outer case 110. The inner chamber 111 may be closed by fastening the outer cover 113 or opened by detaching the outer cover 113. In some cases, the outer cover 113 may be provided with a cover grip 113b for gripping by a user or an opening/closing part.

In some embodiments, a cover fixing flange 114 may be provided at an upper edge of the outer case 110. In addition, a plurality of first cover fixing grooves 114a may be provided in the cover fixing flange 114. In the illustrated embodiment, the first cover fixing groove 114a is formed in a form in which an outer peripheral surface of the cover fixing flange 114 is concavely recessed toward the inner chamber 111. A plurality of first cover fixing grooves 114a may be provided, and the plurality of first cover fixing grooves 114a may be disposed spaced apart at predetermined intervals along the cover fixing flange 114. In addition, the outer cover 113 may be provided with a plurality of second cover fixing grooves 113a that correspond to the first cover fixing groove 114a described above. In the illustrated embodiment, the second cover fixing groove 113a is formed in a form in which the outer peripheral surface of the outer cover 113 is concavely recessed toward the inside of the outer cover 113. A plurality of second cover fixing grooves 113a may be provided, and the plurality of second cover fixing grooves 113a may be disposed spaced apart at predetermined intervals along an outer perimeter of the outer cover 113.

The first and second cover fixing grooves 114a and 113a as described above may be used for coupling the cover fixing flange 114 and the outer cover 113. That is, the outer cover 113 may be detachably fastened to the cover fixing flange 114 by fastening parts such as fastening pins to the first and second cover fixing grooves 114a and 113a.

In some embodiments, a sealing groove 114b may be formed in an upper surface of the cover fixing flange 114. The sealing groove 114b may extend along the cover fixing flange 114 to surround the inner chamber 111. Although not illustrated, a predetermined sealing member may be fastened to the sealing groove 114b, and the sealing member may function to seal a space between the cover fixing flange 114 and the outer cover 113.

Meanwhile, in some embodiments, a case installation flange 115 may be provided at a lower edge of the outer case 110. The case installation flange 115 may extend in the second direction along a lower edge of the outer case 110. In some embodiments, a plurality of case installation flanges 115 may be provided, and the plurality of case installation flanges 115 may be disposed spaced apart in the first direction. In the illustrated embodiment, a pair of case installation flanges 115 are provided and disposed spaced apart in the first direction. In some embodiments, the case installation flange 115 may be formed to have a larger width than that of the cover fixing flange 114 to secure firm fixing and rigidity. The case installation flange 115 allows the outer case 110 to be firmly fixed to an installation surface in response to a thermal runaway test in the inner chamber 111 and may contribute to improving the structural rigidity of the outer case 110.

In some embodiments, the case installation flange 115 may include a plurality of case fixing grooves 115a. In the illustrated embodiment, the case fixing groove 115a is formed in a form in which an outer peripheral surface of the case installation flange 115 is concavely recessed toward the inner chamber 111, similar to the first and second cover fixing grooves 114a and 113a described above. The plurality of case fixing grooves 115a may be provided, and the plurality of case fixing grooves 115a may be disposed spaced apart at predetermined intervals along the case installation flange 115. In the illustrated embodiment, three case fixing grooves 115a are disposed spaced apart in the second direction in one case installation flange 115.

The case fixing groove 115a as described above may be used to fix the outer case 110 to the installation surface. That is, the outer case 110 may be firmly fixed to the installation surface by fastening a fastening part such as a fastening pin to the case fixing groove 115a.

In some embodiments, a water injection port 116 may be provided on the first surface 112a of the outer case 110. The water injection port 116 may be used to supply fire extinguishing water to the inner chamber 111 after the test. A coupling structure such as a flange may be appropriately provided in the water injection port 116 so that an external fire extinguishing water supply part or the like may be properly connected.

In addition, in some embodiments, a first wiring hole 117 may be provided in the second surface 112b of the outer case 110. The first wiring hole 117 may be formed through the second surface 112b of the outer case 110 to provide a path through which a cable or the like may be introduced and installed into the inner chamber 111. The cable may be used to monitor various states of the secondary battery 10 to be tested. For example, the cable may be used to monitor voltage, temperature, gas generation amount, and other states of the secondary battery 10. In some cases, the first wiring hole 117 may be appropriately sealed through a sealing material or the like after installing the cable as described above.

Meanwhile, in some embodiments, the secondary battery test apparatus 100 may include the inner case 120 disposed in the inner chamber 111. The inner case 120 may be formed in a box shape in which the secondary battery 10, the barrier 20, and the like, which are test targets, may be disposed. In the illustrated embodiment, the inner case 120 is illustrated as a box having a substantially rectangular parallelepiped shape that is a predetermined degree smaller than the outer case 110.

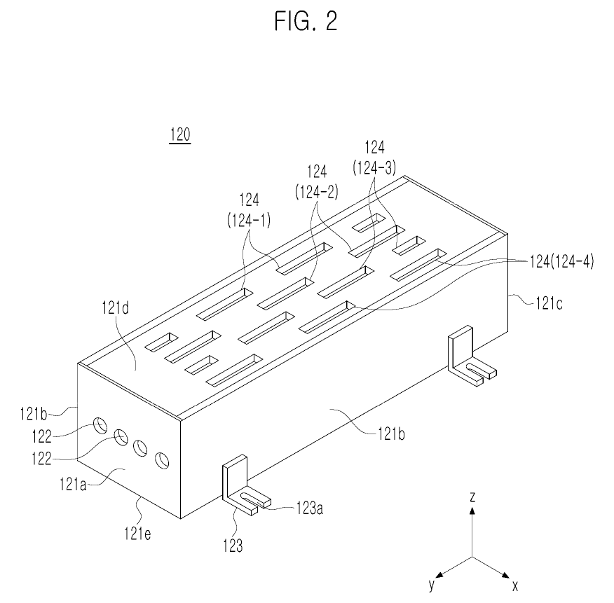

FIG. 2 is a perspective view schematically illustrating a state in which the inner case illustrated in FIG. 1 is separated.

Referring to FIG. 2, in some embodiments, the inner case 120 may have a first surface 121a corresponding to a front surface of a box shape, second surfaces 121b corresponding to left and right side surfaces, a third surface 121c corresponding to the rear surface, a fourth surface 121d corresponding to the upper surface, and a fifth surface 121e corresponding to the lower surface. In the illustrated embodiment, the inner case 120 has a rectangular parallelepiped shape in which a length in the second direction is formed to be a predetermined length longer than a width in the first direction. As described below, a predetermined space where the secondary battery 10 or the like to be tested, is disposed may be provided inside the inner case 120.

In some embodiments, a second wiring hole 122 may be provided in the first surface 121a of the inner case 120. The second wiring hole 122 may pass through the first surface 121a of the inner case 120 and provide a path through which a cable or the like may be introduced and installed into the inner case 120. That is, the cable inserted into the outer case 110 through the first wiring hole 117 described above may be introduced and installed into the inner case 120 through the second wiring hole 122.

In some embodiments, a plurality of second wiring holes 122 may be provided, and the plurality of second wiring holes 122 may be disposed spaced apart in the first surface 121a of the inner case 120 in the first direction. Here, each of the second wiring holes 122 may be disposed in the first surface 121a of the inner case 120 to correspond to each partition space 125 provided inside the inner case 120. Accordingly, the cable may be introduced and installed into each partition space 125. For reference, the illustrated embodiment illustrates a case in which four partition spaces 125 are provided, and accordingly, four second wiring holes 122 are provided to correspond to each partition space 125.

Meanwhile, in some embodiments, a jig fixing bracket 123 may be provided on the second surface 121b of the inner case 120. The jig fixing bracket 123 may be used to fix the inner case 120 to the lower surface of the outer case 110. The jig fixing bracket 123 may be provided with a jig fixing groove 123a. In the illustrated embodiment, the jig fixing groove 123a is formed in a form in which one side surface of the jig fixing bracket 123 is concavely recessed toward the second surface 121b. A plurality of jig fixing brackets 123 may be provided, and the plurality of jig fixing brackets 123 may be disposed spaced apart at predetermined intervals along the second surface 121b of the inner case 120. In the illustrated embodiment, two jig fixing brackets 123 are disposed on one second surface 121b of the inner case 120 in the second direction.

In some embodiments, the jig fixing groove 123a may be formed to extend a predetermined length in the first direction on the jig fixing bracket 123. That is, the jig fixing groove 123a may have a shape of a slit groove extending in the first direction. The jig fixing groove 123a allows the fixing position of the inner case 120 to be adjusted in the outer case 110.

Meanwhile, in some embodiments, a vent hole 124 may be provided in the fourth surface 121d of the inner case 120. The vent hole 124 allows gas generated inside the inner case 120 to be appropriately discharged to the outside of the inner case 120. Here, a plurality of vent holes 124 may be provided, and the plurality of vent holes 124 may be spaced apart from each other in the first direction in the fourth surface 121d of the inner case 120 to correspond to each partition space 125 inside the inner case 120. The vent hole 124 may guide heat, gas, and the like generated in each corresponding partition space 125 to the outside of the inner case 120. Accordingly, it is possible to reduce the effect of heat and gas generated in each partition space 125 during the test process on other adjacent partition spaces 125.

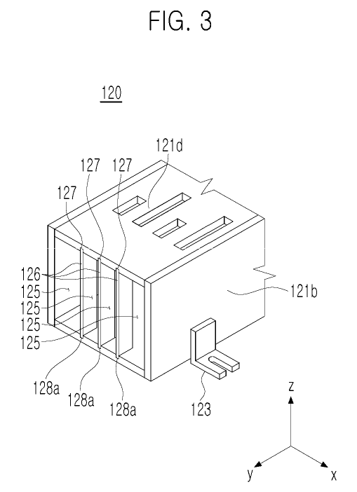

More specifically, in the illustrated embodiment, four sets of vent holes 124 are provided in the fourth surface 121d of the inner case 120 in the first direction. Each set of vent holes 124-1, 124-2, 124-3, and 124-4 includes a plurality of vent holes 124 disposed parallel to each other in the second direction, and each vent hole 124 extends a predetermined length along the second direction. That is, each of the vent holes 124 has the shape of a slit hole extending in the second direction. Here, each set of vent holes 124-1, 124-2, 124-3, and 124-4 is disposed to correspond to each partition space 125 inside the inner case 120. In other words, in the illustrated embodiment, the vent holes 124-1 disposed on the left end are disposed to correspond to the partition space 125 disposed on the left end inside the inner case 120, and the vent holes 124-2 disposed on the right side of the vent holes 124-1 are disposed to correspond to another partition space 125 disposed on the right side of the partition space 125. In addition, other vent holes 124-3 disposed on the right side of the vent holes 124-2 are disposed to correspond to another partition space 125 disposed on the right side of the partition space 125 (see FIG. 3). The plurality of vent holes 124 may be disposed spaced apart in the first direction to correspond to each partition space 125 in this manner.

Meanwhile, the plurality of second wiring holes 122 described above may also be disposed spaced apart in the first direction to correspond to each partition space 125, similar to the above.

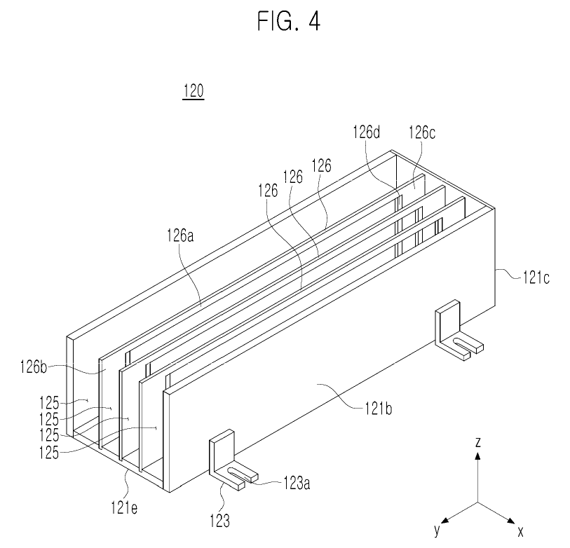

FIG. 3 is a perspective view schematically illustrating a state in which a first surface is removed from the inner case illustrated in FIG. 2. FIG. 4 is a perspective view schematically illustrating a state in which a fourth surface is removed from the inner case illustrated in FIG. 2.

Referring to FIG. 3, in some embodiments, the inner case 120 may have a predetermined inner space, and the inner space of the inner case 120 may be divided into the plurality of partition spaces 125 based on the barrier cover 126. The illustrated embodiment illustrates a case in which four partition spaces 125 are divided based on three barrier covers 126. Each partition space 125 may have a predetermined width in the first direction and may extend in the second direction along the inside of the inner case 120. In addition, the plurality of partition spaces 125 may be disposed in the first direction inside the inner case 120.

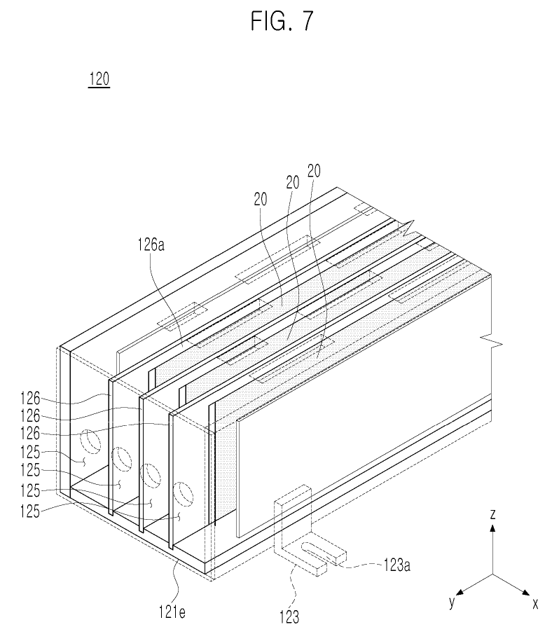

Meanwhile, in some embodiments, the barrier cover 126 and the barrier 20 may be disposed between the partition spaces 125 as described above. For reference, in FIGS. 3 and 4, the barrier 20 is omitted for convenience of illustration. The form in which the barrier 20 is fastened to the barrier cover 126 is illustrated in FIG. 7.

The barrier cover 126 may be fastened to the barrier 20 to be tested and formed to seal a space between the barrier 20 and the inner case 120 between adjacent partition spaces 125. That is, the gap between the barrier 20 and the inner case 120 may be properly closed by the barrier cover 126. Accordingly, heat, gas, and the like generated in a specific partition space 125 may be prevented from flowing into another partition space 125. In addition, more independent and reliable test results may be obtained for each partition space 125.

In some embodiments, the barrier cover 126 may be coupled to the inner case 120 in a firmly locked manner. This allows the barrier cover 126 or the barrier 20 to properly maintain the installation position despite heat and gas generated in each partition space 125.

Specifically, in some embodiments, an upper end cover locking groove 127 may be provided in the fourth surface 121d of the inner case 120. The upper end cover locking groove 127 may be disposed between adjacent partition spaces 125 in the first direction. Alternatively, adjacent partition spaces 125 in the first direction may be divided based on the upper end cover locking groove 127. The upper end cover locking groove 127 may be formed by concavely recessing the lower surface of the fourth surface 121d into a form corresponding to the barrier cover 126. In addition, the upper end cover locking groove 127 may extend in the second direction along the lower surface. An upper end extension portion 126a may be inserted into the upper end cover locking groove 127 to be locked to the barrier cover 126.

In some embodiments, first and second lower end cover locking grooves 128a and 128b may be provided in the fifth surface 121e of the inner case 120. The first and second lower end cover locking grooves 128a and 128b may be disposed between adjacent partition spaces 125 in the first direction to correspond to the upper end cover locking groove 127. The first lower end cover locking groove 128a may be formed by being concavely recessed so that an upper surface of the fifth surface 121e corresponds to the barrier cover 126. In addition, the first lower end cover locking groove 128a may extend a predetermined length in the second direction along the upper surface to correspond to a lower front end portion of the barrier cover 126. That is, the first lower end cover locking groove 128a may extend a predetermined length in the second direction to correspond to the first side end extension portion 126b of the front end of the barrier cover 126. The barrier cover 126 may be locked by inserting the first side end extension portion 126b into the first lower end cover locking groove 128a.

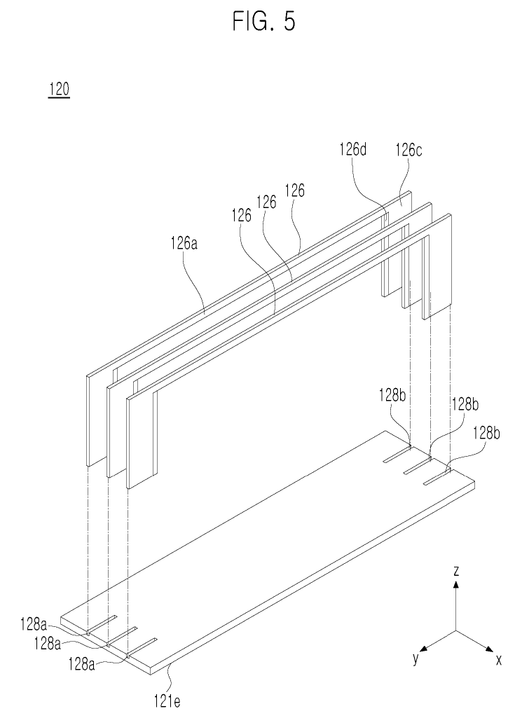

Meanwhile, the second lower end cover locking groove 128b may be provided at the rear end of the fifth surface 121e to correspond to the first lower end cover locking groove 128a in the second direction (see FIG. 5). Similar to the first lower end cover locking groove 128a, the second lower end cover locking groove 128b may be formed by concavely recessing the upper surface of the fifth surface 121e, and may extend a predetermined length in the second direction to correspond to a lower rear end portion of the barrier cover 126. The barrier cover 126 may be locked by inserting a second side end extension portion 126c into the second lower end cover locking groove 128b.

In some embodiments, a plurality of sets of the upper end cover locking grooves 127 and the first and second lower end cover locking grooves 128a and 128b may be provided to correspond to the plurality of partition spaces 125. In the illustrated embodiment, the upper end cover locking groove 127 and the first and second lower end cover locking grooves 128a and 128b are provided in three sets between the partition spaces 125 to correspond to four partition spaces 125. The upper end cover locking groove 127 and the first and second lower end cover locking grooves 128a and 128b of each set may be disposed spaced apart in the first direction within the inner case 120 to correspond to each partition space 125.

FIG. 5 is a perspective view schematically illustrating the barrier cover illustrated in FIG. 4.

Referring to FIG. 5, three first and second lower end cover locking grooves 128a and 128b are formed at the front and rear ends in the fifth surface 121e of the inner case 120 in the illustrated embodiment. In addition, three barrier covers 126 are provided to correspond thereto, and the inside of the inner case 120 is divided into four partition spaces 125.

Meanwhile, in some embodiments, each barrier cover 126 may be formed of a plate-shaped member having a predetermined shape. Specifically, the barrier cover 126 may include the upper end extension portion 126a and the first and second side end extension portions 126b and 126c. The upper end extension portion 126a may form an upper area of the barrier cover 126 and may extend long in the second direction. The upper end extension portion 126a may be disposed between the upper end of the barrier 20 and the fourth surface 121d of the inner case 120 to seal a space between the upper end of the barrier 20 and the fourth surface 121d. That is, the upper end extension portion 126a may be disposed to close a gap between the upper end of the barrier 20 and the inner lower surface of the fourth surface 121d.

The first side end extension portion 126b may extend in the third direction from the front end of the upper end extension portion 126a. The first side end extension portion 126b may have a predetermined width in the second direction and may be disposed between the front end of the barrier 20 and the first surface 121a of the inner case 120 to seal a space between the front end of the barrier 20 and the first surface 121a. That is, the first side end extension portion 126b may be disposed to close a gap between the front end of the barrier 20 and the inner rear surface of the first surface 121a.

In addition, the second side end extension portion 126c may be formed to extend from the rear end of the upper end extension portion 126a to the lower side to correspond to the first side end extension portion 126b. The second side end extension portion 126c may have a predetermined width in the second direction similar to the first side end extension portion 126b, and may be disposed between the rear end of the barrier 20 and the third surface 121c of the inner case 120 to seal a space between the rear end of the barrier 20 and the third surface 121c. That is, the second side end extension portion 126c may be disposed to close a gap between the rear end of the barrier 20 and the inner front surface of the third surface 121c.

The barrier cover 126 may be disposed between the partition spaces 125 in the same configuration as described above, and may function to improve the sealing performance of each partition space 125. Accordingly, it is possible to appropriately limit the propagation of heat, gas, and the like generated in each partition space 125 to other adjacent partition spaces 125.

Meanwhile, in some embodiments, a barrier coupling groove 126d may be provided in an inner periphery of the barrier cover 126 described above. Specifically, the barrier coupling groove 126d may extend along a lower end of the upper end extension portion 126a, a rear end of the first side end extension portion 126b, and a front end of the second side end extension portion 126c. The barrier coupling groove 126d may be formed by concavely recessing the inner periphery of the barrier cover 126 to a predetermined degree, and the upper end, the front end, and the rear end of the barrier 20 may be partially inserted into the barrier coupling groove 126d to be coupled to the barrier cover 126.

In some embodiments, the barrier cover 126 may be formed of a rigid material such as high strength steel to properly withstand heat, pressure, and the like generated during a test process. In some embodiments, the outer surface of the barrier cover 126 may be covered with an insulating material. For example, the outer surface of the barrier cover 126 may be covered with an insulating material such as glass fiber and insulation tape. The insulating material may improve functions such as insulation and blocking through the barrier cover 126, and may contribute to improving the adhesion between the barrier cover 126, the inner case 120, and the barrier 20.

Meanwhile, according to another aspect of the present disclosure, a secondary battery test method may be provided. In some embodiments, the secondary battery test method may be implemented using the secondary battery test apparatus 100 of the above-described embodiment. Hereinafter, the secondary battery test method will be described in more detail, using as an example, the case of using the secondary battery test apparatus 100 of the above-described embodiment.

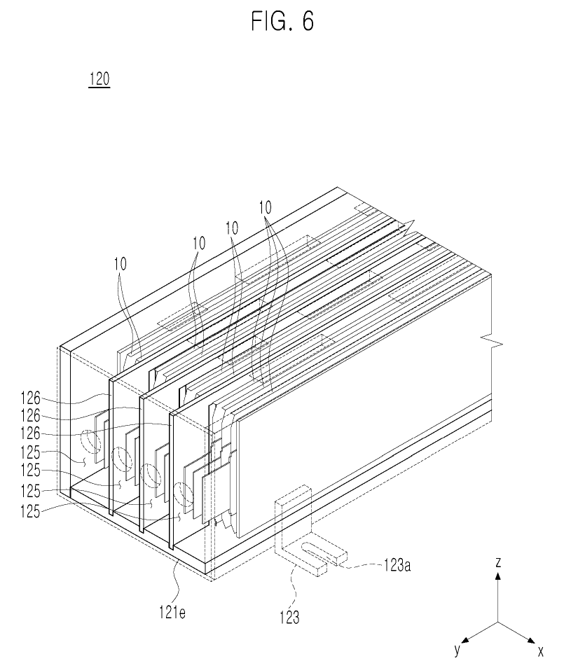

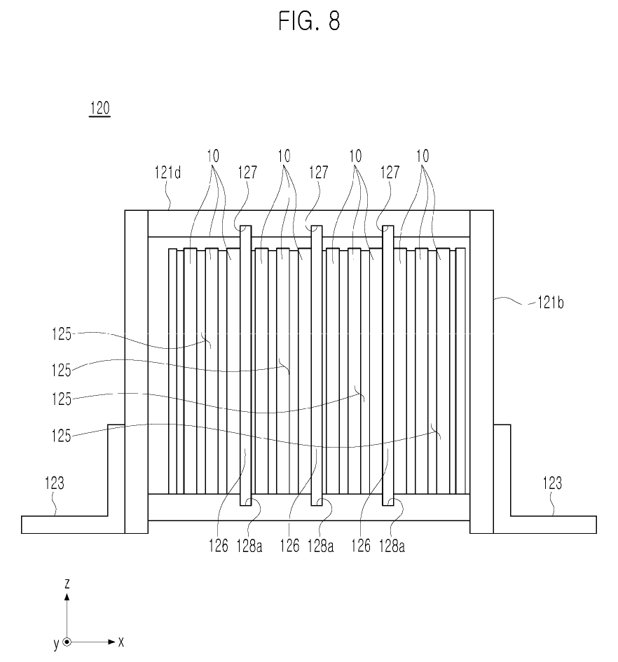

FIG. 6 is a perspective view schematically illustrating a state in which the secondary battery and the barrier, which are test targets, are disposed in the inner case illustrated in FIG. 2. FIG. 7 is a perspective view schematically illustrating a state in which the secondary battery is removed from FIG. 6 and the barrier is disposed. FIG. 8 is a front view schematically illustrating a state in which the first surface of the inner case is removed from FIG. 6 and the secondary battery and the barrier are disposed.

Referring to FIGS. 6 to 8, in some embodiments, the secondary battery test method may include arranging each secondary battery 10 to be tested in the partition spaces 125 provided in the inner case 120, arranging the barrier 20 to be tested and the barrier cover 126 fastened to the barrier 20 between adjacent partition spaces 125, and sealing a space between the adjacent partition spaces by the barrier 20 and the barrier cover 126, arranging the inner case 120 in the inner chamber 111 of the outer case 110, and applying predetermined test conditions to the secondary battery 10 and testing the performance of the secondary battery 10 and the barrier 20 under the applied test conditions.

Specifically, in some embodiments, the secondary battery test method may include arranging each secondary battery 10 to be tested in the partition spaces 125 of the inner case 120. In the illustrated embodiment, the secondary battery 10 is exemplified in the form of a pouch type cell. However, the secondary battery 10 to be tested is not limited to the exemplified form factor. In some embodiments, a plurality of secondary batteries 10 may be disposed in each partition space 125. For example, three secondary batteries 10 may be disposed in one partition space 125, and a total of 12 secondary batteries 10 may be disposed in the inner case 120 when four compartment spaces 125 are provided as illustrated.

Meanwhile, in some embodiments, the secondary battery test method may include arranging the barrier 20 and the barrier cover 126 between adjacent partition spaces 125. The barrier 20 may be a component to be tested together with the secondary battery 10 and may be disposed between the secondary batteries 10 disposed in each partition space 125. The barrier 20 may have performance tested in response to heat and pressure of the secondary battery 10 according to test conditions. The barrier cover 126 may be disposed between each barrier 20 and the inner case 120 so as to properly seal the space between adjacent partition spaces 125. Each partition space 125 may be separated in a more complete form by the barrier cover 126. Accordingly, the influence from other adjacent partition spaces 125 may be reduced.

Meanwhile, a secondary battery 10 of a different type from other partition spaces 125 may be disposed as a test subject in at least some of the plurality of partition spaces 125. In addition, at least some of the plurality of barriers 20 may be provided as a different type of barrier 20 from the other barriers 20, as a test subject.

Specifically, the secondary battery test method may be simultaneously performed on multiple types of secondary batteries 10. The secondary battery 10 of each type may be disposed in each partition space 125, and may be separated from other adjacent partition spaces 125 or other types of secondary batteries 10 disposed therein. Accordingly, the secondary battery 10 of each type may be independently tested in a state in which the influence of heat, gas, and the like transferred from another adjacent partition space 125 is appropriately limited. Similarly, in the secondary battery test method, a test may be simultaneously performed on multiple types of barriers 20. In this case, the barrier cover 126 provided in each barrier 20 may function to limit heat, gas, and the like transferred from other adjacent partition spaces 125.

Meanwhile, in some embodiments, the secondary battery test method may include arranging the inner case 120 to the inside of the outer case 110. In addition, the secondary battery test method may include installing various sensors, cables, and the like before and after the arrangement of the inner case 120. The sensor, the cable, and the like may be appropriately connected to and disposed inside and outside the inner case 120 and the outer case 110 through the first and second wiring holes 117 and 122.

In addition, in some embodiments, the secondary battery test method may include applying predetermined test conditions to the secondary battery 10 and testing the performance of the secondary battery 10 and the barrier 20 accordingly. The voltage, temperature, gas generation amount, and the like of the secondary battery 10 may be tested according to the applied test conditions, and deformation and damage of the barrier 20 corresponding thereto may be tested.

As described above, embodiments of the present disclosure may provide a secondary battery test apparatus and a test method that may be used for testing a secondary battery.

Furthermore, at least some embodiments of the present disclosure may be appropriately used to apply predetermined test conditions to the secondary battery and test the thermal runaway situation of the secondary battery accordingly.

In addition, at least some embodiments of the present disclosure may simultaneously perform a performance test on a plurality of secondary batteries and a plurality of barriers. In at least some embodiments of the present disclosure, a plurality of partition spaces are provided inside the inner case, and different types of secondary batteries or barriers are disposed in each partition space to simultaneously perform a performance test on a plurality of secondary batteries or barriers. In addition, at least some embodiments of the present disclosure may limit the propagation of heat, gases, and the like between the partition spaces through the barrier cover, thereby allowing more reliable test results to be obtained.

In addition, at least some embodiments of the present disclosure may appropriately reduce the cost, time, and resources required for performance tests of secondary batteries and barriers through the above advantages. Furthermore, in some embodiments, the number of secondary cells disposed in each partition space may be appropriately limited, which may contribute to reducing the cost, time, resources, etc. required for performance testing.

Embodiments of the present disclosure can provide a secondary battery test apparatus and a test method that can be used for testing a secondary battery.

In addition, some embodiments of the present disclosure can be appropriately used to apply predetermined test conditions to the secondary battery and test the thermal runaway situation of the secondary battery accordingly.

In addition, some embodiments of the present disclosure can simultaneously perform a performance test on a plurality of secondary batteries and a plurality of barriers. In some embodiments of the present disclosure, a plurality of partition spaces are provided inside an inner case, and different types of secondary batteries or barriers are disposed in each partition space, so that performance tests can be simultaneously performed on a plurality of types of secondary batteries or barriers. In addition, some embodiments of the present disclosure can restrict the propagation of heat and gas between the partition spaces through a barrier cover, thereby obtaining more reliable test results.

In addition, some embodiments of the present disclosure can appropriately reduce the cost, time, and resources required for performance tests of secondary batteries and barriers through the above advantages. In addition, in some embodiments, the number of secondary batteries disposed in each partition space can be appropriately limited, which can contribute to reducing the cost, time, resources, etc. required for performance testing.

The above description is only an example to which the principle of the present disclosure is applied, and other configurations may be further included without departing from the scope of the present disclosure.

What is claimed is:

1. A secondary battery test apparatus comprising:
an outer case having an inner chamber; and
an inner case disposed in the inner chamber,
wherein the inner case includes:
a plurality of partition spaces, in which each secondary battery, which is a test subject, is disposed; and
a barrier cover fastened to a barrier, which is a test subject, between adjacent partition spaces to seal a space between the barrier and the inner case between the adjacent partition spaces.

2. The secondary battery test apparatus of claim 1, wherein the outer case includes:
an outer cover that opens and closes the inner chamber;
a cover fixing flange extending along an upper edge of the outer case;
a plurality of first cover fixing grooves provided along the cover fixing flange; and
a plurality of second cover fixing grooves provided along an edge of the outer cover so as to correspond to the plurality of first cover fixing grooves.

3. The secondary battery test apparatus of claim 1, wherein the outer case includes:
a case installation flange extending in a second direction along a lower edge of the outer case;
a plurality of case fixing grooves provided in the case installation flange to fix the case installation flange to an installation surface;
a water injection port provided on one surface of the outer case to supply fire extinguishing water to the inner chamber; and
a first wiring hole provided in another surface of the outer case to provide a path through which an external cable is introduced and installed into the inner chamber.

4. The secondary battery test apparatus of claim 1, wherein each of the partition spaces has a predetermined width in a first direction and extends in a second direction, and
the plurality of partition spaces are disposed in the first direction inside the inner case.

5. The secondary battery test apparatus of claim 1, wherein the barrier cover includes:
an upper end extension portion extending in a first direction between an upper end of the barrier and an upper surface part of the inner case to seal a space between the upper end of the barrier and the upper surface part of the inner case;
a first side end extension portion extending downward from one end portion of the upper end extension portion to seal a space between one end portion of the barrier and a first surface of the inner case; and
a second side end extension portion extending downward from an opposite end portion of the upper end extension portion to correspond to the first side end extension portion to seal a space between the opposite end portion of the barrier and a third surface of the inner case.

6. The secondary battery test apparatus of claim 1, wherein a barrier coupling groove into which the barrier is inserted and fastened is provided in an inner periphery of the barrier cover.

7. The secondary battery test apparatus of claim 1, wherein an outer surface of the barrier cover is covered with a thermally insulating material.

8. The secondary battery test apparatus of claim 1, wherein the inner case includes:
an upper end cover locking groove into which an upper end of the barrier cover is inserted and locked;
a first lower end cover locking groove into which a lower front end portion of the barrier cover is inserted and locked; and
a second lower end cover locking groove into which a lower rear end portion of the barrier cover is inserted and locked to correspond to the first lower end cover locking groove.

9. The secondary battery test apparatus of claim 8, wherein a plurality of sets of the upper end cover locking grooves and the first and second lower end cover locking grooves are disposed spaced apart in the inner case to correspond to the plurality of partition spaces.

10. The secondary battery test apparatus of claim 1, wherein the inner case includes a plurality of second wiring holes disposed spaced apart in a first surface of the inner case to correspond to the plurality of partition spaces, and
each of the second wiring holes provides a path through which an external cable is introduced and installed into each of the partition spaces.

11. The secondary battery test apparatus of claim 1, wherein the inner case includes a plurality of jig fixing brackets provided at a lower end of a second surface of the inner case so that the inner case is fixed to a lower surface of the outer case, and
each of the jig fixing brackets includes a jig fixing groove extending in a first direction to adjust a fixing position of the inner case with respect to the outer case.

12. The secondary battery test apparatus of claim 1, wherein the inner case includes a plurality of vent holes disposed in an upper surface of the inner case to correspond to each of the partition spaces, and
Each of the plurality of vent holes guides gas generated in each of the partition spaces to the outside of the inner case.

13. The secondary battery test apparatus of claim 1, wherein at least some of the plurality of partition spaces are provided with a secondary battery of a different type from the other partition spaces as a test subject, and
at least some of a plurality of barriers disposed between adjacent partition spaces are provided as different types of barriers from the other barriers, as test subjects.

14. A secondary battery test method comprising:
arranging each secondary battery to be tested in a plurality of partition spaces provided in an inner case;
arranging a barrier to be tested and a barrier cover fastened to the barrier between adjacent partition spaces, and sealing a space between the adjacent partition spaces by the barrier and the barrier cover;
arranging the inner case in an inner chamber of an outer case; and
applying predetermined test conditions to the secondary battery and testing performance of the secondary battery and the barrier under the applied test conditions.

15. The secondary battery test method of claim 14, wherein the barrier cover includes:
an upper end extension portion extending in a first direction between an upper end of the barrier and an upper surface part of the inner case to seal a space between the upper end of the barrier and the upper surface part of the inner case;
a first side end extension portion extending downward from one end portion of the upper end extension portion to seal a space between one end portion of the barrier and a first surface of the inner case; and
a second side end extension portion extending downward from an opposite end portion of the upper end extension portion to correspond to the first side end extension portion to seal a space between the opposite end portion of the barrier and a third surface of the inner case.

16. The secondary battery test method of claim 14, wherein the inner case includes:
an upper end cover locking groove into which an upper end of the barrier cover is inserted and locked;
a first lower end cover locking groove into which a lower front end portion of the barrier cover is inserted and locked; and
a second lower end cover locking groove into which a lower rear end portion of the barrier cover is inserted and locked to correspond to the first lower end cover locking groove.

17. The secondary battery test method of claim 14, wherein, at least some of the plurality of partition spaces are provided with a secondary battery of a different type from the other partition spaces as a test subject, and
at least some of a plurality of barriers disposed between adjacent partition spaces are provided as different types of barriers from the other barriers, as test subjects.
